(19) United States
(12) Patent Application Publication
(10) Pub. No.: US 2024/0386472 A1
(43) Pub. Date: Nov. 21, 2024

(54) Personalized Product/Offer Recommendation Matching System

(71) Applicant: Redpoint Global, Wellesley, MA (US)

(72) Inventor: Vincent William Porto, Encinitas, CA (US)

(21) Appl. No.: 18/317,129

(22) Filed: May 15, 2023

(51) Int. Cl. G06Q 30/0601; G06Q 30/0251

(52) U.S. Cl. CPC G06Q 30/0631; G06Q 30/0255; G06Q 30/0269; G06Q 30/0641

(57) ABSTRACT

Embodiments included herein are directed towards a method for generating personalized recommendations. Embodiments may include identifying a plurality of behavioral features corresponding to a specific customer and assigning a weight to the plurality of behavioral features. Embodiments may further include determining product/offer features corresponding to the behavioral features and identifying product identifiers associated with the product/offer features. Embodiments may also include extracting feature keywords based upon the product identifiers. Embodiments may further include receiving, from a graphical user interface, at least one of a behavioral feature weight and a product offer feature weight and generating a score for each product/offer based upon the plurality of behavioral features corresponding to the specific customer and a weighting factor that includes the behavioral feature weight and the product offer feature weight. Embodiments may further include causing a display of a product offer corresponding to a highest ranked score to the specific customer.

### BACKGROUND

Electronic commerce has revolutionized the way in which products and services are now acquired and consumed. Providing potential customers with the most appropriate good or service at the most appropriate time and in the most appropriate manner is a constant struggle. Virtually all existing recommendation engines utilize a technique called collaborative filtering which attempts to utilize the information from other customers that is deemed sufficiently similar to generate predictive recommendations. This group-think approach is dependent upon the accuracy of like-customer similarity measures. It also requires a large number of data records from similar customers to create valid predictions. The computational complexity of collaborative filtering results in large CPU and memory requirements, leading to long training times and often unrealistic limits on the size of the applicable feature space.

### SUMMARY

In one or more embodiments of the present disclosure, a computer-implemented method for generating personalized recommendations is provided. The method may include identifying a plurality of behavioral features corresponding to a specific customer and assigning a weight to the plurality of behavioral features. The method may further include determining product/offer features corresponding to the behavioral features and identifying product identifiers associated with the product/offer features. The method may also include extracting feature keywords based upon the product identifiers. The method may further include receiving, from a graphical user interface, at least one of a behavioral feature weight and a product offer feature weight and generating a score for each product/offer based upon the plurality of behavioral features corresponding to the specific customer and a weighting factor that includes the behavioral feature weight and the product offer feature weight. The method may further include causing a display of a product offer corresponding to a highest ranked score to the specific customer.

One or more of the following features may be included. In some embodiments, causing the display may include causing a display of the plurality of product offers. The behavioral features may include one or more of demographic data, prior purchasing behavior, messaging interaction, surveys, and client/consumer interaction data. The method may further include regenerating an updated score based upon, updated behavioral features corresponding to the specific customer. The method may also include regenerating an updated score based upon, updated product/offer changes. The product/offer features may include physical features and constituent information within a product/offer messaging description. Assigning and determining may be performed without data from other customers.

In another embodiment of the present disclosure, a non-transitory computer readable storage medium having stored thereon instructions, which when executed by a processor result in one or more operations is provided. Operations may include identifying a plurality of behavioral features corresponding to a specific customer and assigning a weight to the plurality of behavioral features. Operations may further include determining product/offer features corresponding to the behavioral features and identifying product identifiers associated with the product/offer features. Operations may also include extracting feature keywords based upon the product identifiers. Operations may further include receiving, from a graphical user interface, at least one of a behavioral feature weight and a product offer feature weight and generating a score for each product/offer based upon the plurality of behavioral features corresponding to the specific customer and a weighting factor that includes the behavioral feature weight and the product offer feature weight. Operations may further include causing a display of a product offer corresponding to a highest ranked score to the specific customer.

One or more of the following features may be included. In some embodiments, causing the display may include causing a display of the plurality of product offers. The behavioral features may include one or more of demographic data, prior purchasing behavior, messaging interaction, surveys, and client/consumer interaction data. Operations may further include regenerating an updated score based upon, updated behavioral features corresponding to the specific customer. Operations may also include regenerating an updated score based upon, updated product/offer changes. The product/offer features may include physical features and constituent information within a product/offer messaging description. Assigning and determining may be performed without data from other customers.

In one or more embodiments of the present disclosure, a system for generating personalized recommendations is provided. The system may include a computing device having at least one processor and a memory. The at least one processor may be configured to identify a plurality of behavioral features corresponding to a specific customer and to assign a weight to each of the plurality of behavioral features. The at least one processor may be further configured to determine one or more product/offer features corresponding to the plurality of behavioral features and to identify one or more product identifiers associated with the one or more product/offer features. The at least one processor may be configured to extract one or more feature keywords based upon, at least in part, the one or more product identifiers and configured to receive, from a graphical user interface, at least one of a behavioral feature weight and a product offer feature weight. The at least one processor may be further configured to generate a score for each product/offer based upon, at least in part, the plurality of behavioral features corresponding to the specific customer and a weighting factor that includes the behavioral feature weight and the product offer feature weight and to cause a display of a product offer corresponding to a highest ranked score to the specific customer.

One or more of the following features may be included. In some embodiments, causing the display may include causing a display of the plurality of product offers. The behavioral features may include one or more of demographic data, prior purchasing behavior, messaging interaction, surveys, and client/consumer interaction data. The at least one processor may be further configured to regenerate an updated score based upon, updated behavioral features corresponding to the specific customer. The at least one processor may be further configured to regenerate an updated score based upon, updated product/offer changes. The product/offer features may include physical features and constituent information within a product/offer messaging description. Assigning and determining may be performed without data from other customers.

Additional features and advantages of embodiments of the present disclosure will be set forth in the description which follows, and in part will be apparent from the description, or may be learned by practice of embodiments of the present disclosure. The objectives and other advantages of the embodiments of the present disclosure may be realized and attained by the structure particularly pointed out in the written description and claims hereof as well as the appended drawings.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 diagrammatically depicts a recommendation process coupled to a distributed computing network;

FIG. 2 depicts a flowchart showing an example recommendation process consistent with embodiments of the present disclosure;

FIG. 3 depicts a scoring function flow diagram consistent with embodiments of the present disclosure;

FIG. 4 depicts an example feature space keyword preprocessing algorithm consistent with embodiments of the present disclosure;

FIG. 5 depicts an example feature space product/offer scoring algorithm consistent with embodiments of the present disclosure;

FIG. 6 depicts behavioral input feature space and behavioral information weights examples consistent with embodiments of the present disclosure;

FIG. 7 depicts an example of product/offer/message input feature keyword extraction consistent with embodiments of the present disclosure;

FIG. 8 depicts an example product/offer/message input feature space weighting consistent with embodiments of the present disclosure;

FIG. 9 depicts a behavioral feature function weighting example consistent with embodiments of the present disclosure;

FIG. 10 depicts a product/offer input features example consistent with embodiments of the present disclosure;

FIG. 11 depicts a personalized product/offer recommendation example consistent with embodiments of the present disclosure; and

FIGS. 12-14 illustrate an example personalized product/offer recommendation graphical user interfaces according to embodiments of the present disclosure.

### DETAILED DESCRIPTION

As discussed above, virtually all existing recommendation engines utilize a technique called collaborative filtering which attempts to utilize the information from other customers that is deemed sufficiently similar to generate predictive recommendations. The computational complexity of collaborative filtering results in large CPU and memory requirements, leading to long training times and often unrealistic limits on the size of the applicable feature space. Accordingly, embodiments of the recommendation process described herein may avoid these requirements as the process is not reliant on information from other similar users, instead it utilizes the behavioral information of each individual customer as a separate entity. As such, training times are greatly reduced as well as the required amount of computational resources required to produce predictions. Embodiments of the recommendation process described herein do not rely on the behaviors of other customers. In contrast, the recommendation predictions described herein are highly personal, resulting in more appropriate, customized customer-client interactions.

Reference will now be made in detail to the embodiments of the present disclosure, examples of which are illustrated in the accompanying drawings. The present disclosure may, however, be embodied in many different forms and should not be construed as being limited to the embodiments set forth herein; rather, these embodiments are provided so that this disclosure will be thorough and complete, and will fully convey the concept of the present disclosure to those skilled in the art. Like reference numerals in the drawings denote like elements.

### System Overview

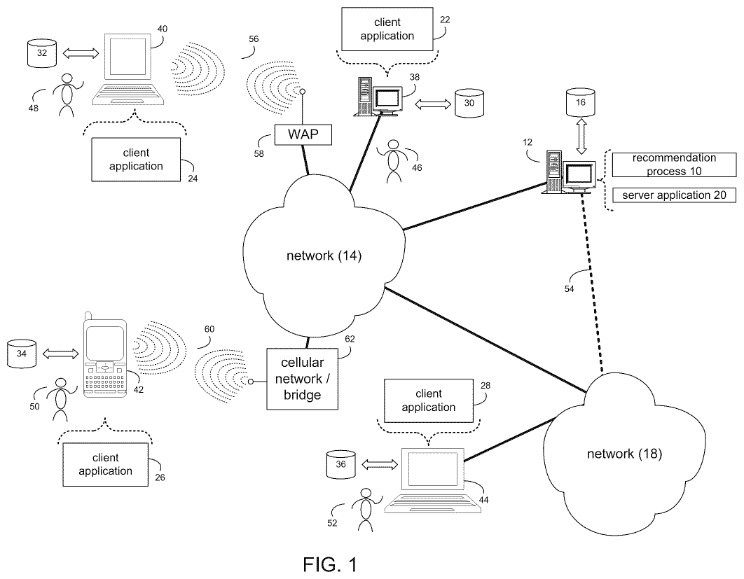

Referring to FIG. 1, there is shown a recommendation process 10 that may reside on and may be executed by server computer 12, which may be connected to network 14 (e.g., the internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally and/or alternatively, recommendation process 10 may reside on a client electronic device, such as a personal computer, notebook computer, personal digital assistant, or the like.

The instruction sets and subroutines of recommendation process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Microsoft Exchange™ Server. Server application 20 may interact with one or more client applications (e.g., client applications 22, 24, 26, 28) in order to execute recommendation process 10. Examples of client applications 22, 24, 26, 28 may include, but are not limited to, design verification tools such as those available from the assignee of the present disclosure. These applications may also be executed by server computer 12. In some embodiments, recommendation process 10 may be a stand-alone application that interfaces with server application 20 or may be applets/applications that may be executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition/as an alternative to being server-based applications residing on server computer 12, recommendation process 10 may be a client-side application residing on one or more client electronic devices 38, 40, 42, 44 (e.g., stored on storage devices 30, 32, 34, 36, respectively). As such, recommendation process 10 may be a stand-alone application that interface with a client application (e.g., client applications 22, 24, 26, 28), or may be applets/applications that may be executed within a client application. As such, recommendation process 10 may be a client-side process, server-side process, or hybrid client-side/server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, recommendation process 10 may be a cloud-based process as any or all of the operations described herein may occur, in whole, or in part, in the cloud or as part of a cloud-based system. The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g. Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™. Redhat Linux™, Apple IOS, ANDROID, or a custom operating system.

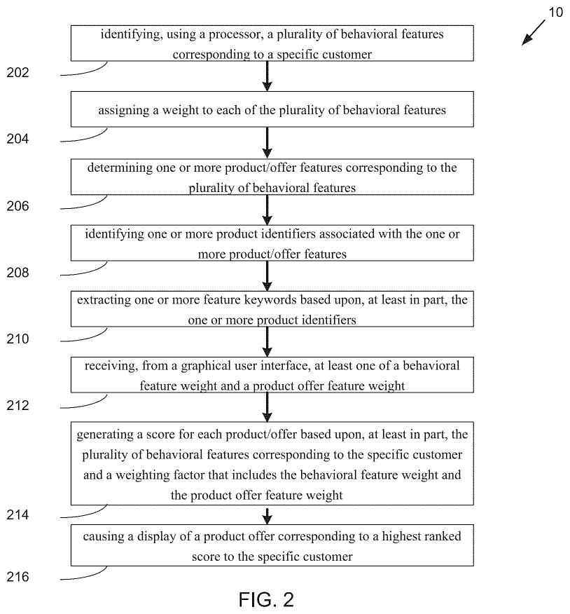

Referring now to FIG. 2, a flowchart showing one or more operations consistent with embodiments of recommendation process 10 is provided. The method may include identifying (202) a plurality of behavioral features corresponding to a specific customer and assigning (204) a weight to the plurality of behavioral features. The method may further include determining (206) product/offer features corresponding to the behavioral features and identifying (208) product identifiers associated with the product/offer features. The method may also include extracting (210) feature keywords based upon the product identifiers. The method may further include receiving (212), from a graphical user interface, at least one of a behavioral feature weight and a product offer feature weight and generating (214) a score for each product/offer based upon the plurality of behavioral features corresponding to the specific customer and a weighting factor that includes the behavioral feature weight and the product offer feature weight. The method may further include causing (216) a display of a product offer corresponding to a highest ranked score to the specific customer. Numerous additional operations are also within the scope of the present disclosure, which are discussed in further detail hereinbelow.

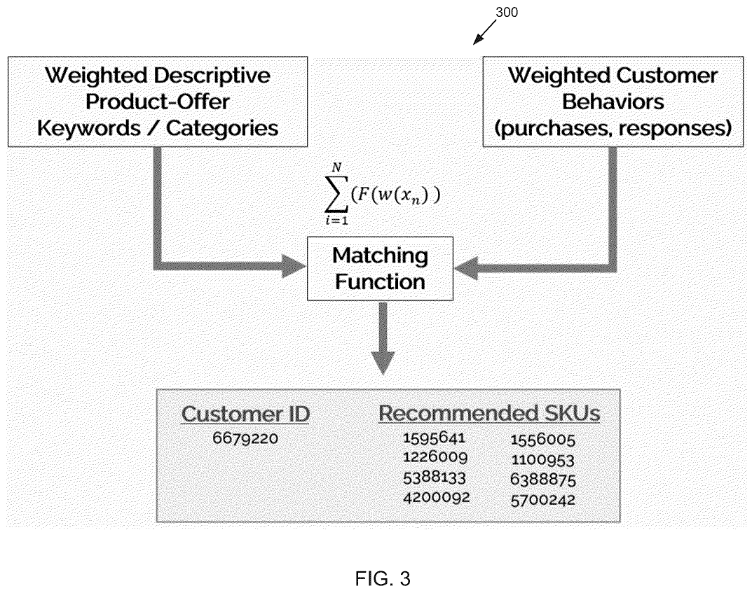

Referring now to FIGS. 3-14, additional diagrams consistent with embodiments of recommendation process 10 are provided. Embodiments of recommendation process 10 may be used for generating personalized recommendations for products, offers, messaging, etc. based on a customer's behavioral information and product/offer characteristics. In some embodiments, individually weighted behavioral features, combined with individually weighted product/offer features may be used in a flexible scoring function to assign predictive values. Since recommendation process 10 does not rely on collaborative filtering (which requires input features obtained from other customer information) it operates independently of access to other customer information and utilizes considerably less computer resources (e.g., memory, CPU). Recommendation process 10 may generate predictions that may be scored, accessed, and/or updated in real-time and the process also allows for dynamic re-weighting/re-scoring on-the-fly to facilitate constant or periodically changing business goals.

As discussed above, typical product/offer recommendation algorithms utilize a collaborative filtering (i.e., group-think) approach to predict what to present to the end user. This highly impersonal approach, relies on the information from other customers who are deemed similar to make predictions, thus requiring data from other customers during training. In contrast, recommendation process 10 may utilize only unique customer information, some of which may include, but is not limited to, behaviors, surveys, purchases, etc. Recommendation process 10 may then match it against the set of products, offers, or other messaging content. Weights may be set by a client company, which may then be applied to individual behaviors (e.g., purchases).

In some embodiments, recommendation process 10 may allow for the weighing of product/offer information based upon individual features in the product/offer feature set. Product/offer features may be extracted using any suitable approach, including, but not limited to, directly from a database, file, or other source. In some embodiments, features may also be extracted (e.g., scraped) from website information, catalogs, messaging content, etc.

In some embodiments, training may be accomplished on a customer-by-customer basis, and may be updated whenever either the set of customer behaviors (e.g., purchases) changes, or the product/offer set changes (e.g., due to availability).

In some embodiments, recommendation process 10 may generate one or more match scores for each product/offer, with the results sorted by score. Recommendation process 10 may then report one or more items for presentation and subsequent use. Additional post-processing may be performed to re-sort/re-score based on other customer criteria (e.g., promotional characteristics, profitability, seasonality). Recommendation process 10 does not utilize other customers' behaviors and, as such, it is highly personal and may be trained and operated in real-time. Additionally and/or alternatively, recommendation process 10 may be combined with information from other recommendation engines to operate as a hybrid-system.

In some embodiments, recommendation process 10 may receive basic functional input data from a variety of different sources such as those shown in FIG. 1. Some of these inputs may include, but are not limited to, customer data with previous purchase history (e.g., products) along with personal preferences (e.g., from website forms, surveys, etc.), product data (e.g., descriptive keywords, brand information, sizes, etc. for each product in the inventory), etc. Recommendation process 10 may generate one or more prediction outputs, which may be based upon, at least in part, the basic functional input data. Some prediction outputs may include, but are not limited to, a set of product/offer/message IDs, which may be tailored to best match each customer's preferences and history.

In some embodiments, recommendation process 10 may be configured to quantize one or more personal behaviors by identifying a suitable feature space that encompasses relevant preferences, historical interactions, purchases, and information exchanges. The quantization process is discussed in further detail below.

In some embodiments, a first quantization operation may include identifying behavioral features from a specific customer (or source). These features may include, but are not limited to, demographic data (e.g., age, marital status, location, family relationship(s), financial data), prior purchasing behavior (e.g., products, services), messaging interaction (e.g., replies to emails, facebook advertisements, direct mail messages), surveys, and responses to other types of client-consumer interactions. These may constitute the space of known behavioral information over a designated period of time. Feature spaces may be represented as generalized or more specific categories (e.g., “flavor”, “size”, “brand”). Each of these features may be assigned a weight indicative of the benefit, significance, profitability, and/or other relevance to the needs of the company at the time of capture. Behavioral information feature weights may also be set to account for temporal aspects. For example, older interactions/purchases/survey results may be de-weighted to emphasize more recent behavioral events.

In some embodiments, a second quantization operation may include the acquisition of product/offer features corresponding to the space of behavioral information. These may include, but are not limited to, physical features (e.g., color, size, weight, fragrance, quantity) as well as constituent information within product/offer/messaging description (e.g., brand names, font color/size, image content, discounts, text information, time-related promotions).

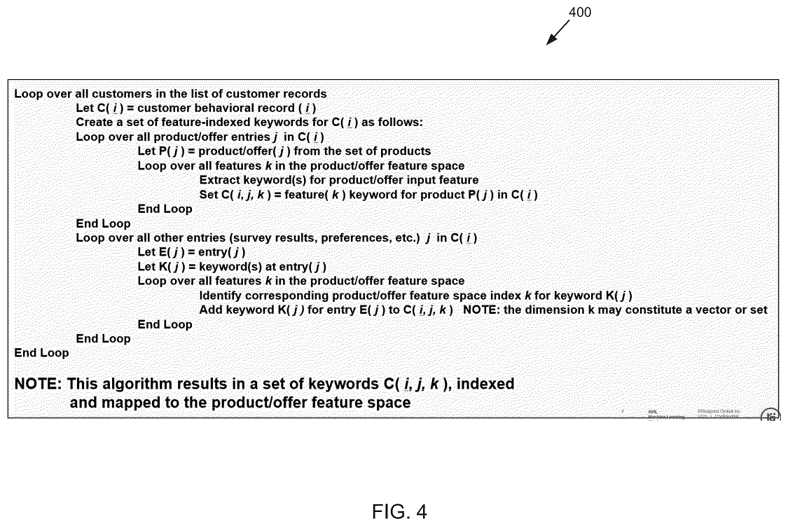

In some embodiments, and referring again to FIG. 3, a diagram 300 consistent with embodiments of recommendation process 10 is provided. In this particular example, inputs from the product/offer keyword feature space and customer behavioral feature space (e.g., responses, purchases) are combined within a weighting function to create scores useful for generating and subsequent ranking product/offer recommendations. More specifically, diagram 300 includes weighted descriptive product/offer keywords/categories and weighted customer behaviors (e.g. purchases, responses, etc.) that are received at a matching function. In some embodiments, product/offer identifiers (e.g., SKU) may be used to initiate a search within the product/offer feature space to extract the set of “keywords” (e.g., “Red”, “blouse”, “10%”) associated with that feature. Accordingly, these keywords may include one or more extensions which may include, but are not limited to, multi-word phrases (e.g., “Super Sale Event”, “6-pack”), phonemes (e.g., textual, spectral, and time series representations), and other descriptive measures. For example, the SKU “P00024” may result in the color feature keyword “blue”, size feature keyword “large”, product class feature keyword “shoe”, and brand name feature keyword “Nike”. Each of these product/offer features may be assigned a weight corresponding to the goals of the client company. Product/offer weights may be assigned per their relevance to product availability, profitability, seasonality, stock levels, or any other pertinent company concern. FIG. 4 depicts an example feature space keyword preprocessing algorithm consistent with embodiments of the present disclosure. This particular example shows customer product/offer behavioral feature extraction and processing.

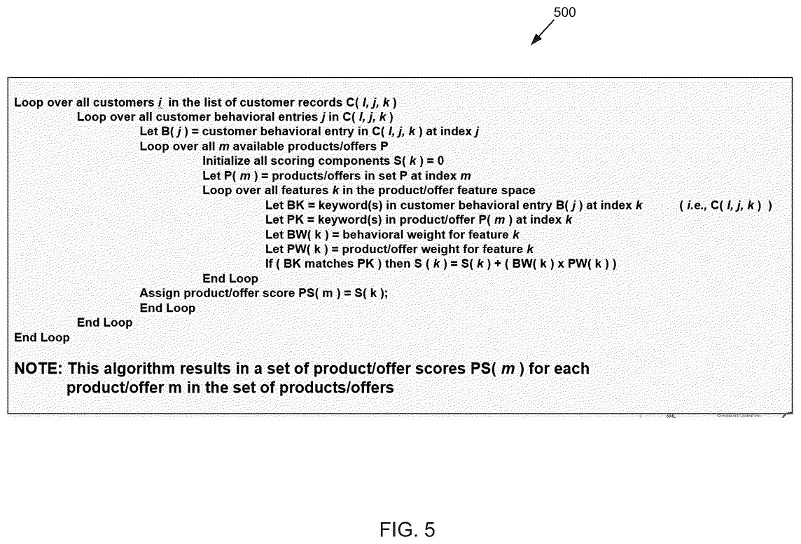

In some embodiments, and referring now to FIG. 5, a third quantization operation may include a scoring operation. This particular example shows algorithmic extraction of keyword information from a) the product/offer feature space from customer historical behaviors (e.g., purchase SKUs, website visits), and b) other customer interactions (e.g., surveys, customer response preferences), such that they comprise a set of keywords indexed and mapped into the feature/offer feature space for subsequent comparative matching and scoring operations. More specifically, FIG. 5 depicts an example feature space product/offer scoring algorithm consistent with embodiments of recommendation process 10. This example shows customer product/offer behavioral feature scoring. Accordingly, for each element in the customer behavioral space a search may be performed over the feature space of the product/offer set. For each match detected, the scoring function value may be increased by the product of the weighting factors (e.g., behavioral feature weight for the feature multiplied by the product/offer feature weight). Thus, each product/offer may be assigned a score relevant to the weighted matches between its inherent features and the historical information acquired for the customer. Multiple matches may be additive (e.g., two matches for the brand “Nike” double the additive component for the score). The final score may be calculated by summing over all entries within the entire customer behavioral feature spaces (over a defined period of time).

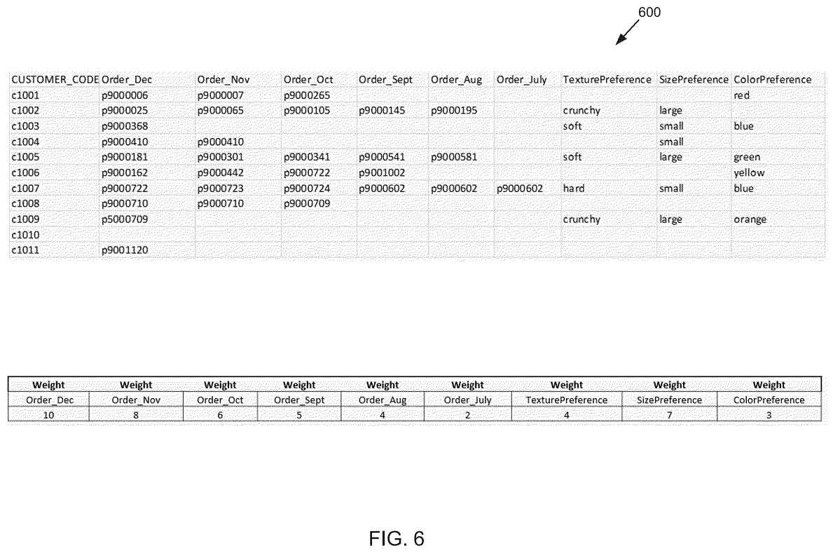

FIG. 6 shows an example behavioral input feature space and behavioral information weights example. The depiction at the top of FIG. 6 provides an example of customer behavioral data with customer identifiers, purchases over a quantized time period (e.g., product SKUs), and additional preference information (e.g., from survey, and/or other sources). The depiction at the bottom of FIG. 6 shows weighting factors, as assigned by the client for each of the behavioral keyword categories, for subsequent use in the scoring function. This process may include a score recording operation. As such, the set of recommendations, along with their associated scores, may be saved for each individual customer being processed. These may be saved in direct memory (e.g., RAM) for rapid recall, memory cache, database, file, or transferred/transmitted to other consuming processes.

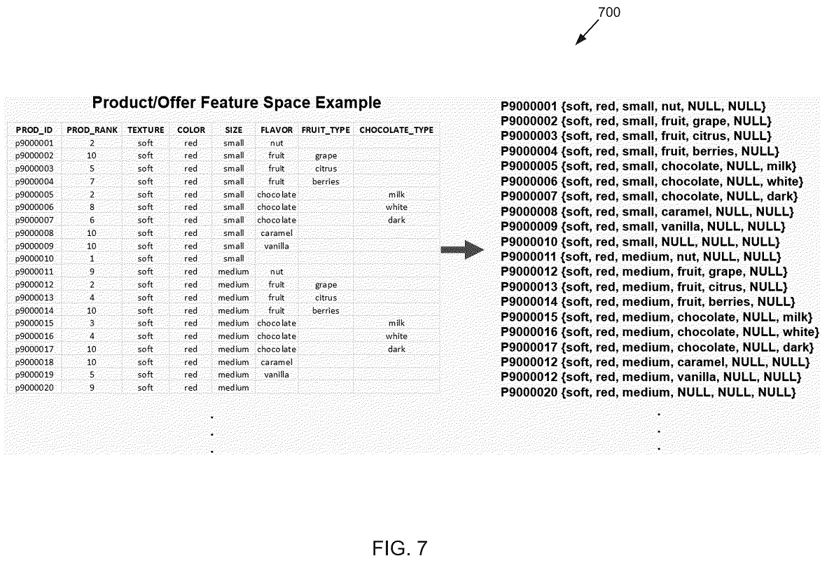

Referring again to FIG. 7, an embodiment showing a product/offer/message input feature keyword extraction example is provided. This particular example shows the extraction of feature keywords, indexed by product/offer ID, from the set of products/offers to be used in the weighted scoring process.

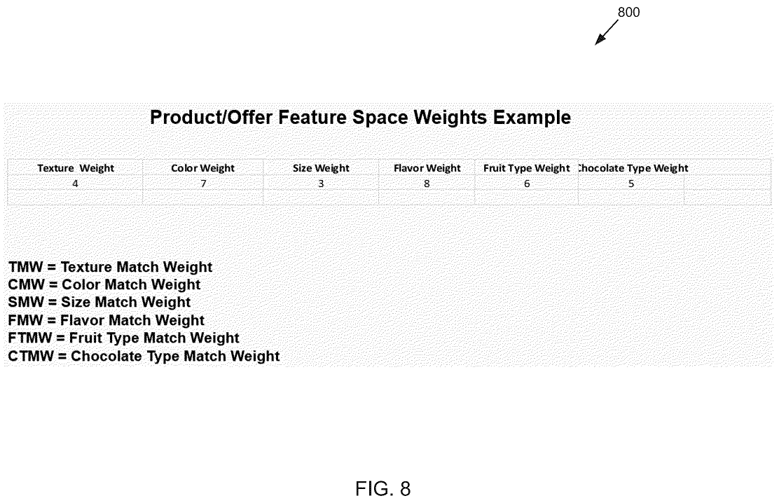

FIG. 8 shows a product/offer/message input feature space weighting example. This particular example shows weighting factors, as assigned by the client for each of the product/offer keyword categories, for subsequent use in the scoring function.

In some embodiments, normalization may be performed using the total number of matches found, the number of possible matches (within the customer behavioral space and/or product/offer features space, the number of behavioral features for the specific customer regardless of the number of matches, the number of product/offer features regardless of the number of matches), the sum of feature weights, or any other appropriate normalization (e.g., rescaling) operation. Some or all of the operations above may be repeated for each customer in the data set.

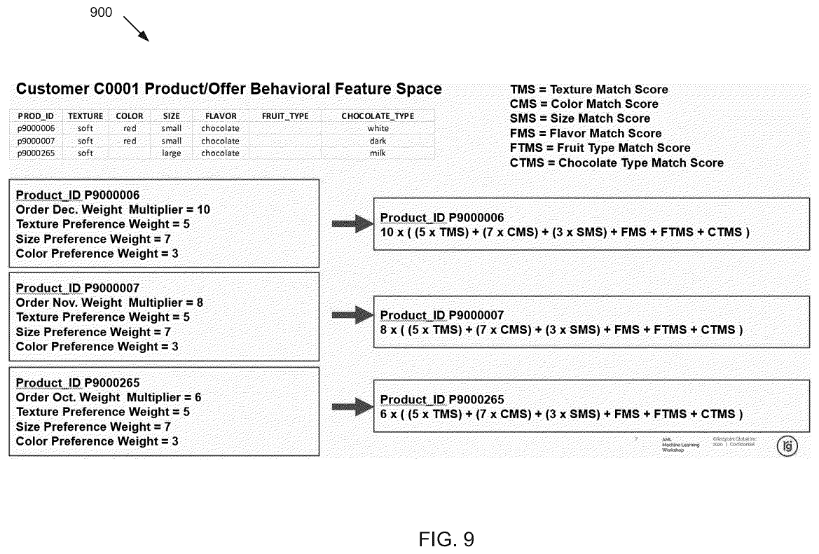

Referring again to FIG. 9, a diagram showing a behavioral feature function weighting example consistent with embodiments of the present disclosure is provided. This example shows a weighting function wherein weights (as shown in FIG. 6) are applied to customer purchases in Dec., Nov., and Oct.) to create weighted matching scores for the individual products purchased by the customer with unique identifier C0001.

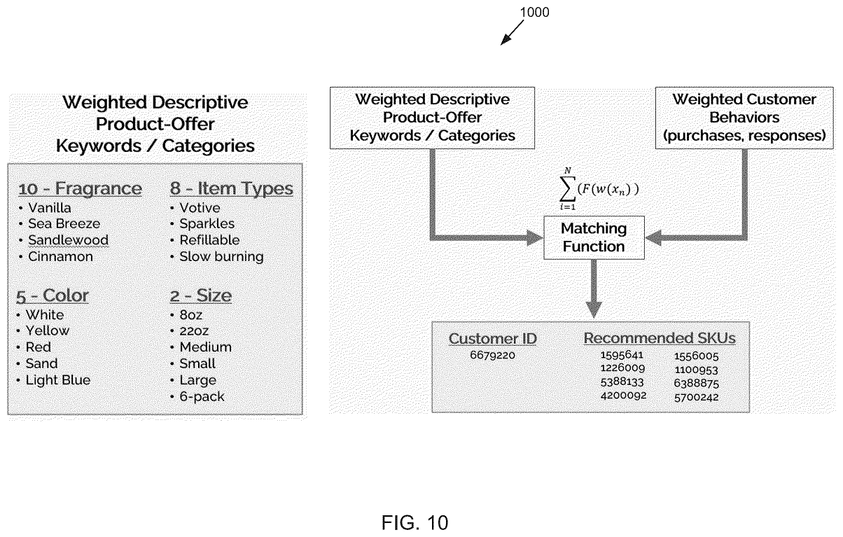

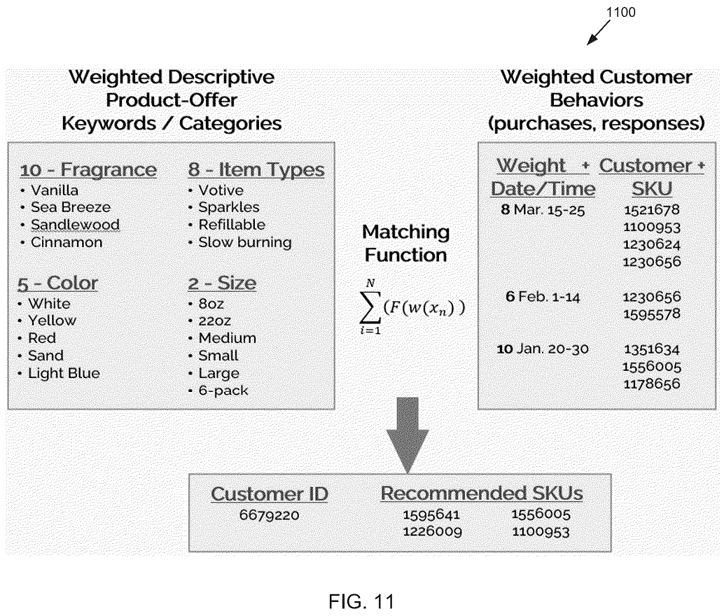

FIGS. 10-11 show a product/offer input features example consistent with embodiments of the present disclosure. In this example, shown at the left of FIG. 10 are individual product/offer keywords for several descriptive categories (e.g., Fragrance, Color, Size), along with the product/offer category weights. At the right of FIG. 10 is a depiction of the predictive process flow showing 1) product/offer and customer behavioral inputs, 2) the weighted scoring function, and 3) outputs (e.g., a set of recommended SKUs for a specific customer with identifier. At the right of FIG. 10 is a depiction of the predictive process flow showing 1) product/offer and customer behavioral inputs, 2) the weighted scoring function, and 3) outputs (e.g., a set of recommended SKUs for a specific customer with identifier.

Referring again to FIG. 11, at the left is a depiction of individual product/offer descriptive categories (e.g., Fragrance, Color, Size), along with the product/offer category weights and various associated keywords within the category. On the right in FIG. 11 is a depiction of individual customer behaviors (product SKUs with associated purchase dates) prior to keyword extraction (as depicted in FIG. 7). Both of these inputs are used in the scoring function which produces predictive recommendation outputs for the specific customer ID.

In some embodiments, prioritization may be performed to refine/tailor the recommendations per end-user requirements. After scoring, the resultant list of recommendations may be prioritized using any suitable approach. Some of these may include, sorting by score, sorting by number of matches, and/or by other client-driven goal or criteria (e.g., product availability). In some embodiments, customers with no matches may be assigned scores based on any suitable approach. Some of these may include, but are not limited to, pre-defined client preferential offerings, randomized selection within the set (or subset) of products/offerings, etc. This may allow for cases with no matching components across both feature spaces (e.g., new, previously unknown customers).

In some embodiments, given sufficient historical data, recommendation process 10 may produce a set of product(s)/offer(s) that, after prioritization, may be presented to the customer within a messaging (or other interactive) system. It should be noted that since the products/offers have ranked scores, instead of a single recommendation, embodiments of recommendation process 10 may allow for the presentation of multiple recommendations and/or messages to the customer; as an entire set, or as a subset (i.e., top N) as a carousel offering.

In some embodiments, recommendation process 10 may perform a rescoring operation. In order to maintain currency with dynamic environments, rescoring may be performed as the product/offer space changes and/or as changes are recorded within the customer behavioral data. It should be noted that this may be achieved in static and dynamic environments by also changing the weighting components if/as the goals of the company changes. A sliding time window may also be used to refine the historical behavioral data such that is pertinent to company operations (e.g., seasonality, trends, periodic sale events).

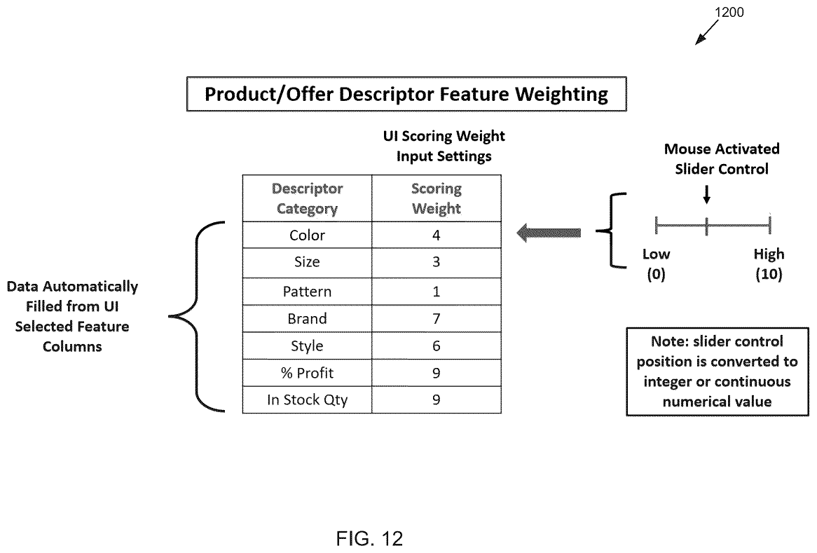

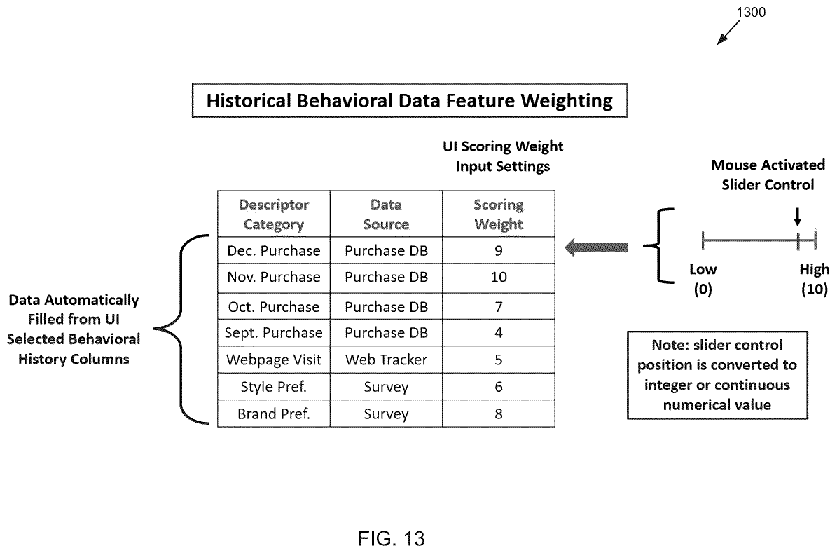

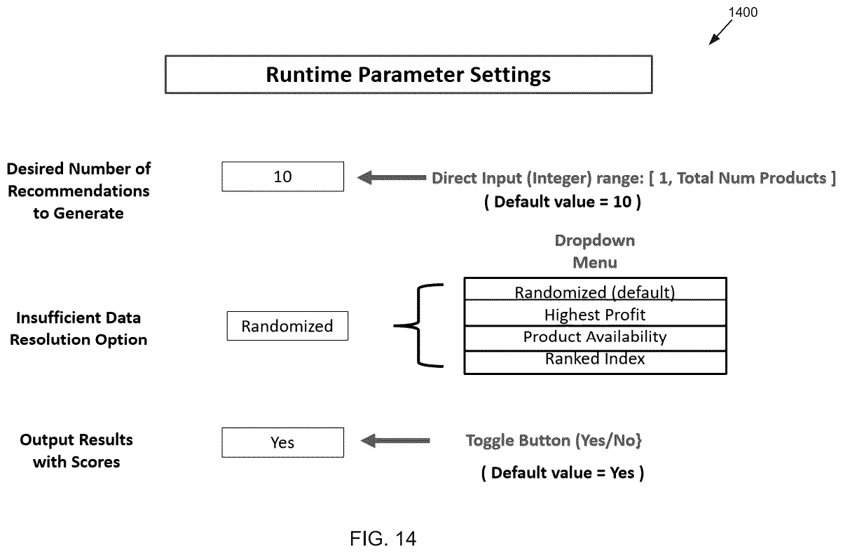

Referring also to FIGS. 12-14, example graphical user interfaces that may be generated using recommendation process 10 are provided. FIG. 12 shows an example depicting a product/offer descriptor feature weighting. FIG. 13 shows an example depicting a historical behavioral data feature weighting. FIG. 14 shows an example depicting runtime parameter settings. More specifically, FIG. 12 depicts a user interface wherein weights for each individual product/offer category are set via a slide-bar UI control. The UI automatically fills the category labels from the input data source (or user-filtered subset thereof), with default weight settings shown for subsequent user modification if/as desired. Similarly, FIG. 13 depicts a user interface wherein weights for each individual customer behavioral category are set via a slide-bar UI control. Descriptor labels, data sources, and default weight setting values for each category facilitate ease of use. Default weights need not be uniform, and may be pre-set based on individualized client-user requirements. FIG. 14 depicts a user interface wherein run-time parameters may be set. These include, but are not limited to 1) the number of recommendations to generate for each customer ID. 2) options for handling cases where insufficient customer behavioral data exists to generate predictions via keyword match scoring mechanism (e.g., randomized selection, rank-ordering by availability, profitability, or other data), and 3) an option to output predictive matching scores in addition to the predicted recommendations. As with the other UI control interfaces, default parameter/option values facilitate ease of use, and may be custom-tailored to meet individual client-user requirements.

In some embodiments, recommendation process 10 may also include an automated API-based system, a fully automated mechanism to extract salient customer behavioral features from databases, one or more product/offer feature extraction systems (e.g., scrape catalog text for keywords, context, and pre-process into usable feature sets), a user-interface that allows for manually and/or automatically setting weights for both the customer and product/offer feature sets.

It will be apparent to those skilled in the art that various modifications and variations can be made to recommendation process 10 and/or embodiments of the present disclosure without departing from the spirit or scope of the invention. Thus, it is intended that embodiments of the present disclosure cover the modifications and variations of this invention provided they come within the scope of the appended claims and their equivalents.

What is claimed is:

1. A computer-implemented method, comprising:
identifying, using a processor, a plurality of behavioral features corresponding to a specific customer;
assigning a weight to each of the plurality of behavioral features;
determining one or more product/offer features corresponding to the plurality of behavioral features;
identifying one or more product identifiers associated with the one or more product/offer features;
extracting one or more feature keywords based upon, at least in part, the one or more product identifiers;
receiving, from a graphical user interface, at least one of a behavioral feature weight and a product offer feature weight;
generating a score for each product/offer based upon, at least in part, the plurality of behavioral features corresponding to the specific customer and a weighting factor that includes the behavioral feature weight and the product offer feature weight; and
causing a display of a product offer corresponding to a highest ranked score to the specific customer.

2. The computer-implemented method of claim 1, wherein causing the display includes causing a display of the plurality of product offers.

3. The computer-implemented method of claim 1, wherein the behavioral features include one or more of demographic data, prior purchasing behavior, messaging interaction, surveys, and client/consumer interaction data.

4. The computer-implemented method of claim 1, further comprising:
regenerating an updated score based upon, updated behavioral features corresponding to the specific customer.

5. The computer-implemented method of claim 1, further comprising:
regenerating an updated score based upon, updated product/offer changes.

6. The computer-implemented method of claim 1, wherein the product/offer features include physical features and constituent information within a product/offer messaging description.

7. The computer-implemented method of claim 1, wherein assigning and determining are performed without data from other customers.

8. A non-transitory computer readable storage medium having stored thereon instructions, which when executed by a processor result in one or more operations, the operations comprising:
identifying, using a processor, a plurality of behavioral features corresponding to a specific customer;
assigning a weight to each of the plurality of behavioral features;
determining one or more product/offer features corresponding to the plurality of behavioral features;
identifying one or more product identifiers associated with the one or more product/offer features;
extracting one or more feature keywords based upon, at least in part, the one or more product identifiers;
receiving, from a graphical user interface, at least one of a behavioral feature weight and a product offer feature weight;
generating a score for each product/offer based upon, at least in part, the plurality of behavioral features corresponding to the specific customer and a weighting factor that includes the behavioral feature weight and the product offer feature weight; and
causing a display of a product offer corresponding to a highest ranked score to the specific customer.

9. The non-transitory computer readable storage medium of claim 8, wherein causing the display includes causing a display of the plurality of product offers.

10. The non-transitory computer readable storage medium of claim 8, wherein the behavioral features include one or more of demographic data, prior purchasing behavior, messaging interaction, surveys, and client/consumer interaction data.

11. The non-transitory computer readable storage medium of claim 8, wherein operations further comprise:
regenerating an updated score based upon, updated behavioral features corresponding to the specific customer.

12. The non-transitory computer readable storage medium of claim 8, wherein operations further comprise:
regenerating an updated score based upon, updated product/offer changes.

13. The non-transitory computer readable storage medium of claim 8, wherein the product/offer features include physical features and constituent information within a product/offer messaging description.

14. The non-transitory computer readable storage medium of claim 8, wherein assigning and determining are performed without data from other customers.

15. A system comprising a computing device having at least one processor and a memory, wherein the at least one processor is configured to:
identify, using a processor, a plurality of behavioral features corresponding to a specific customer;
assign a weight to each of the plurality of behavioral features;
determine one or more product/offer features corresponding to the plurality of behavioral features;
identify one or more product identifiers associated with the one or more product/offer features;
extract one or more feature keywords based upon, at least in part, the one or more product identifiers;
receive, from a graphical user interface, at least one of a behavioral feature weight and a product offer feature weight;
generate a score for each product/offer based upon, at least in part, the plurality of behavioral features corresponding to the specific customer and a weighting factor that includes the behavioral feature weight and the product offer feature weight; and
cause a display of a product offer corresponding to a highest ranked score to the specific customer.

16. The system of claim 15, wherein causing the display includes causing a display of the plurality of product offers.

17. The system of claim 15, wherein the behavioral features include one or more of demographic data, prior purchasing behavior, messaging interaction, surveys, and client/consumer interaction data.

18. The system of claim 15, wherein operations further comprise:
regenerating an updated score based upon, updated behavioral features corresponding to the specific customer.

19. The system of claim 15, wherein operations further comprise:
regenerating an updated score based upon, updated product/offer changes.

20. The system of claim 15, wherein the product/offer features include physical features and constituent information within a product/offer messaging description.
